(19) United States
(12) Patent Application Publication
(10) Pub. No.: US 2025/0308521 A1
(43) Pub. Date: Oct. 2, 2025

(54) APPARATUS, METHOD, AND NON-TRANSITORY RECORDING MEDIUM

(71) Applicants: Chihiro ASADA, Tokyo (JP); Masaki NOSE, Kanagawa (JP); Yuuto GOTOH, Kanagawa (JP)

(72) Inventors: Chihiro ASADA, Tokyo (JP); Masaki NOSE, Kanagawa (JP); Yuuto GOTOH, Kanagawa (JP)

(21) Appl. No.: 19/082,239

(22) Filed: Mar. 18, 2025

(30) Foreign Application Priority Data
Mar. 29, 2024 (JP) 2024-057018

(51) Int. Cl. G10L 15/22; G10L 25/63

(52) U.S. Cl. CPC G10L 15/22; G10L 25/63

(57) ABSTRACT

An apparatus includes circuitry that detects a first speech of a user. The circuitry controls a dialog agent to output a response to the first speech that is detected. The circuitry controls the dialog agent to output a second speech for facilitating dialog with the user before outputting the response, when a predetermined condition is satisfied.

### CROSS-REFERENCE TO RELATED APPLICATION

This patent application is based on and claims priority pursuant to 35 U.S.C. § 119 (a) to Japanese Patent Application No. 2024-057018, filed on Mar. 29, 2024, in the Japan Patent Office, the entire disclosure of which is hereby incorporated by reference herein.

### BACKGROUND

### Technical Field

The present disclosure relates to an apparatus, a method, and a non-transitory recording medium.

### Related Art

A dialog system in which a dialog agent automatically responds to a message from a user has been proposed. For example, a voice dialog method is proposed. The voice dialog method includes inputting a user speech, extracting a prosodic feature of the input user speech, and generating a response to the user speech based on the extracted prosodic feature. The prosody of the response is adjusted so that the prosodic feature of the response matches the prosodic feature of the user speech.

### SUMMARY

The present disclosure described herein provides an apparatus. The apparatus includes circuitry, and the circuitry detects a first speech of a user. The circuitry controls a dialog agent to output a response to the first speech that is detected. The circuitry controls the dialog agent to output a second speech for facilitating dialog with the user before outputting the response, when a predetermined condition is satisfied.

The present disclosure described herein provides a method. The method includes detecting a first speech of a user. The method includes controlling a dialog agent to output a response to the first speech detected by the detecting. The method includes controlling the dialog agent to output a second speech for facilitating dialog with the user before outputting the response, when a predetermined condition is satisfied.

The present disclosure described herein provides a non-transitory recording medium storing a plurality of instructions which, when executed by one or more processors, causes the one or more processors to perform a method. The method includes detecting a first speech of a user. The method includes controlling a dialog agent to output a response to the first speech detected by the detecting. The method includes controlling the dialog agent to output a second speech for facilitating dialog with the user before outputting the response, when a predetermined condition is satisfied.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a dialog system;

FIG. 2 is a diagram illustrating an example of a dialog agent;

FIG. 3 is a diagram illustrating another example of a dialog agent;

FIG. 4 is a diagram illustrating an example of a hardware configuration of a computer;

FIG. 5 is a diagram illustrating an example of a hardware configuration of a terminal apparatus;

FIG. 6 is a diagram illustrating an example of a functional configuration of a server apparatus according to a first embodiment;

FIG. 7 is a sequence diagram illustrating an example of a flow of a dialog according to a comparative example;

FIG. 8 is a sequence diagram illustrating an example of a flow of a dialog according to the first embodiment;

FIG. 9 is a flowchart illustrating an example of a dialog method according to the first embodiment;

FIG. 10 is a flowchart illustrating an example of speech detection processing according to a second embodiment;

FIG. 11 is a diagram illustrating an example of a functional configuration of a server apparatus according to a third embodiment;

FIG. 12 is a diagram illustrating an example of emotion determining rules according to the third embodiment;

FIG. 13 is a diagram illustrating an example of a behavior determination rule according to the third embodiment;

FIG. 14 is a flowchart illustrating an example of emotion recognition processing according to the third embodiment;

FIG. 15 is a diagram illustrating an example of a functional configuration of a server apparatus according to a fourth embodiment;

FIG. 16 is a sequence diagram illustrating an example of a flow of a dialog according to the fourth embodiment; and

FIG. 17 is a flowchart illustrating an example of motion detection processing according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an embodiment of the present disclosure with reference to the drawings. In the drawings, identical or similar reference signs designate components having identical or similar functions, and redundant descriptions are omitted in the following description.

### First Embodiment

A first embodiment of the present disclosure is an information processing system that provides a dialog service. The information processing system is referred to as a “dialog system” below. The dialog service is one example of an information communication service that enables conversation with a dialog agent. For this reason, the dialog system is one example of an information communication system. In the dialog service, the dialog agent automatically responds to a message from a user, and a dialog between the user and the dialog agent progresses.

### System Configuration

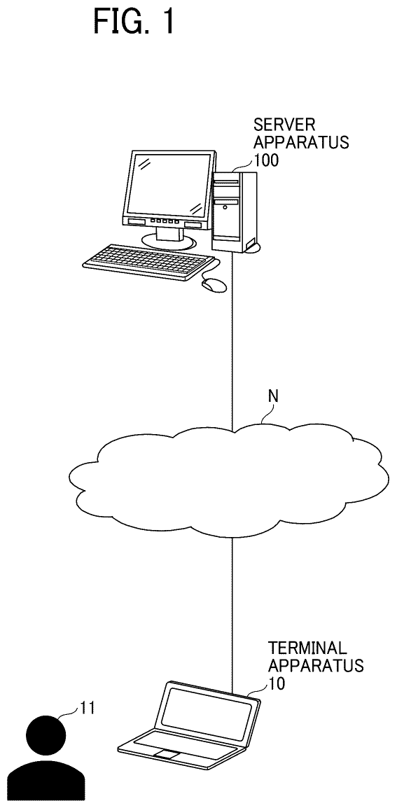

FIG. 1 is a diagram illustrating an example of a system configuration of the dialog system. In the example illustrated in FIG. 1, the dialog system 1 includes a server apparatus 100 and a terminal apparatus 10 connected to a communication network N such as the Internet or a local area network (LAN).

The server apparatus 100 is one example of an information processing apparatus implemented by a computer or a system including a plurality of computers. In one example, the server apparatus 100 provides the dialog service in which the computer operating as the server apparatus 100 executes a predetermined program to cause the dialog agent to automatically respond to a message from a user 11 who uses the terminal apparatus 10. In other words, the server apparatus 100 controls a dialog with the user 11 using the dialog agent. The server apparatus 100 is an example of a dialog apparatus.

The terminal apparatus 10 is an information terminal such as a personal computer (PC), a tablet terminal, or a smartphone used by the user 11. The terminal apparatus 10 communicates with the server apparatus 100 via the communication network N. The user 11 uses the terminal apparatus 10 to use the dialog service provided by the server apparatus 100. In other words, the user 11 interacts with the dialog agent through the dialog service.

Preferably, the dialog system 1 supports the execution of a predetermined task such as business negotiation or nursing care by a dialog in which the dialog agent automatically responds to a message from the user 11.

The system configuration of the dialog system 1 illustrated in FIG. 1 is an example. The terminal apparatus 10 is not limited to a general-purpose information terminal, and may be, e.g., a dedicated terminal apparatus or any type of electronic device. Alternatively, the dialog system 1 may be implemented by, e.g., a single information processing apparatus implemented by a computer. The following description will be given on the assumption that the dialog system 1 has a system configuration as illustrated in FIG. 1.

### Dialog Agent

The dialog agent is a system that automatically responds to a question from a user, such as a customer, by using, e.g., knowledge including information and knowledge previously registered into the system, or artificial intelligence (AI).

As a use case of the dialog agent, the dialog agent may be used as, e.g., an unmanned AI avatar in a web conference, a web site, a smartphone application, or a METAVERSE space.

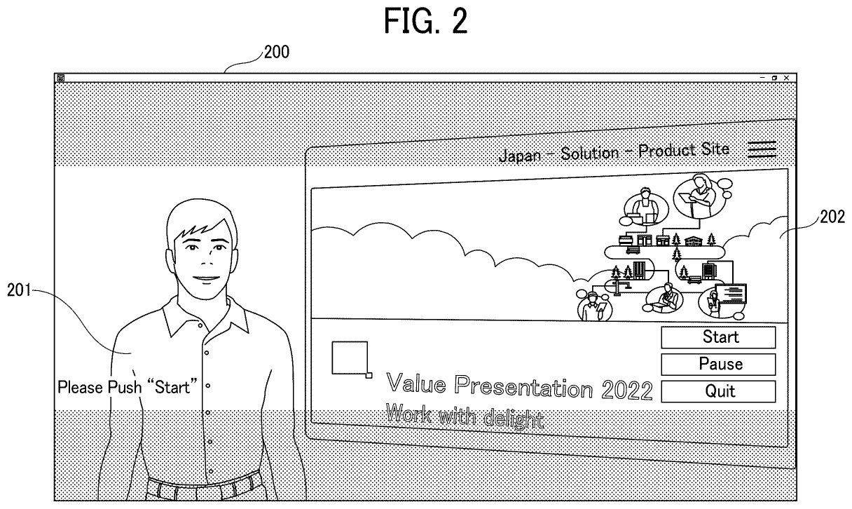

FIG. 2 illustrates an example of an image representing a dialog agent. This figure illustrates an example of a dialog screen 200 for a business negotiation that the server apparatus 100 causes the terminal apparatus 10 to display. In the example illustrated in FIG. 2, the dialog screen 200 displays a virtual human 201 generated by three-dimensional (3D) modeling. The virtual human 201 is an example of the dialog agent. For example, the server apparatus 100 controls the virtual human 201 to proceed with a business negotiation while having a dialog with the user 11 on the dialog screen 200.

As a preferred example, the dialog screen 200 for a business negotiation displays a large-sized display section 202. The server apparatus 100 may also control the display section 202 to display, e.g., a product proposed to the user and cause the virtual human 201 to explain the product.

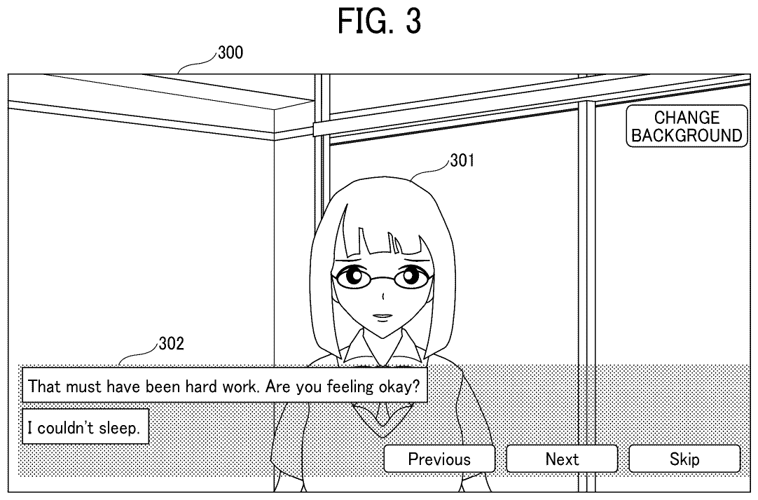

FIG. 3 illustrates another example of an image representing the dialog agent. This figure illustrates an example of a dialog screen 300 for nursing care use that the server apparatus 100 causes the terminal apparatus 10 to display. In the example illustrated in FIG. 3, another virtual human 301 generated by the 3D modeling is displayed on the dialog screen 300, in a substantially similar manner as illustrated in FIG. 2. The virtual human 301 is another example of the dialog agent. The server apparatus 100 controls the virtual human 301 to perform, e.g., communication for preventing dementia with an elderly person living alone as a target on the dialog screen 300.

As illustrated in FIG. 3, the dialog between the user 11 and the virtual human 301 may be a dialog 302 expressed as a character string in addition to (or instead of) voice.

In this way, the dialog system 1 may change a dialog content in accordance with various applications such as business negotiation, nursing care, class, or counseling by changing a dialog scenario.

### Hardware Configuration

### Hardware Configuration of Computer

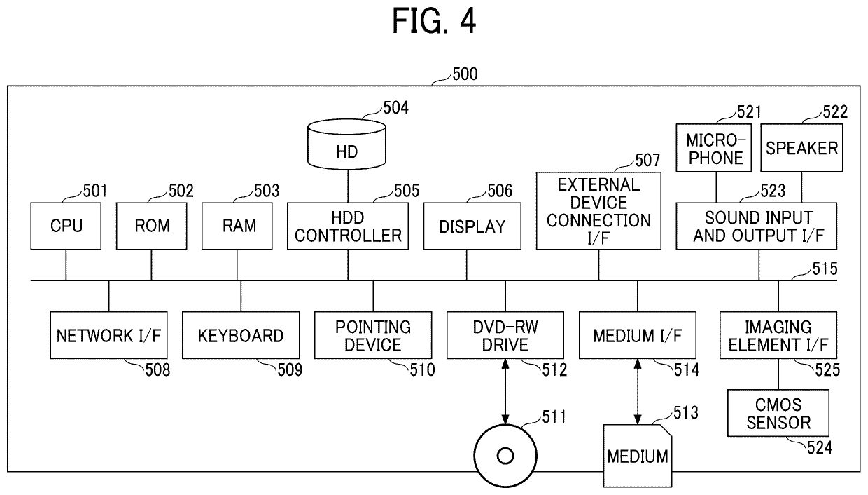

The server apparatus 100 is implemented by a computer 500 having at least a part of a hardware configuration illustrated in FIG. 4. Alternatively, the server apparatus 100 includes a plurality of computers each of which is implemented by the computer 500. The terminal apparatus 10 may have, for example, a hardware configuration of the computer 500 as illustrated in FIG. 4.

FIG. 4 is a diagram illustrating an example of a hardware configuration of a computer according to an embodiment. The computer 500 includes, e.g., a central processing unit (CPU) 501, a read-only memory (ROM) 502, a random-access memory (RAM) 503, a hard disk (HD) 504, an HD drive (HDD) controller 505, a display 506, an external device connection interface (I/F) 507, a network I/F 508, a keyboard 509, a pointing device 510, a digital versatile disc-rewritable (DVD-RW) drive 512, a medium I/F 514, and a bus line 515, as illustrated in FIG. 4.

In addition, in a case where the computer 500 is the terminal apparatus 10, the computer 500 further includes, e.g., a microphone 521, a speaker 522, a sound input and output I/F 523, a complementary metal oxide semiconductor (CMOS) sensor 524, and an imaging element I/F 525.

The CPU 501 controls the entire operation of the computer 500. The ROM 502 stores a program used for executing the computer 500, such as an initial program loader (IPL). The RAM 503 is used as, e.g., a work area for the CPU 501. The HD 504 stores, e.g., programs including an operating system (OS), an application, and a device driver, and various data. For example, the HDD controller 505 controls reading or writing of various data from or to the HD 504 under control of the CPU 501. The HD 504 is an example of storage devices.

The display 506 displays various information such as a cursor, a menu, a window, characters, or an image. The display 506 may be provided separately from the computer 500. The external device connection I/F 507 is an interface for connecting various external devices to the computer 500. The network I/F 508 is an interface for connecting the computer 500 to the communication network N to communicate with other devices.

The keyboard 509 is one example of input device including multiple keys used for inputting, e.g., characters, numerical values, or various instructions. The pointing device 510 is another example of input device used to, for example, select various instructions, execute various instructions, select a target for processing, and move a cursor. The keyboard 509 and the pointing device 510 may be provided separately from the computer 500.

The DVD-RW drive 512 reads and writes various data from and to a DVD-RW 511 which is an example of a removable recording medium. The removable recording medium is not limited to a DVD-RW such as the DVD-RW 511 and may be any other type of removable recording medium. The medium I/F 514 controls reading or writing (storing) of data from or to the medium 513 such as a flash memory. The bus line 515 includes an address bus and a data bus. The bus line 515 electrically connects the above-described components to each other and transmits, for example, various control signals.

The microphone 521 is a built-in circuit that converts sound into an electrical signal. The speaker 522 is a built-in circuit that generates sound such as music or voice by converting an electrical signal into physical vibration. The sound input and output I/F 523 is a circuit that processes input and output of audio signals between the microphone 521 and the speaker 522 under the control of the CPU 501.

The CMOS sensor 524 is one example of a built-in imaging device that captures an object (e.g., a self-image of the user) under control of the CPU 501 to obtain image data. The computer 500 may include any desired imaging device such as a charge coupled device (CCD) sensor instead of the CMOS sensor 524. The imaging element I/F 525 is a circuit that controls the driving of the CMOS sensor 524.

### Hardware Configuration of Terminal Apparatus

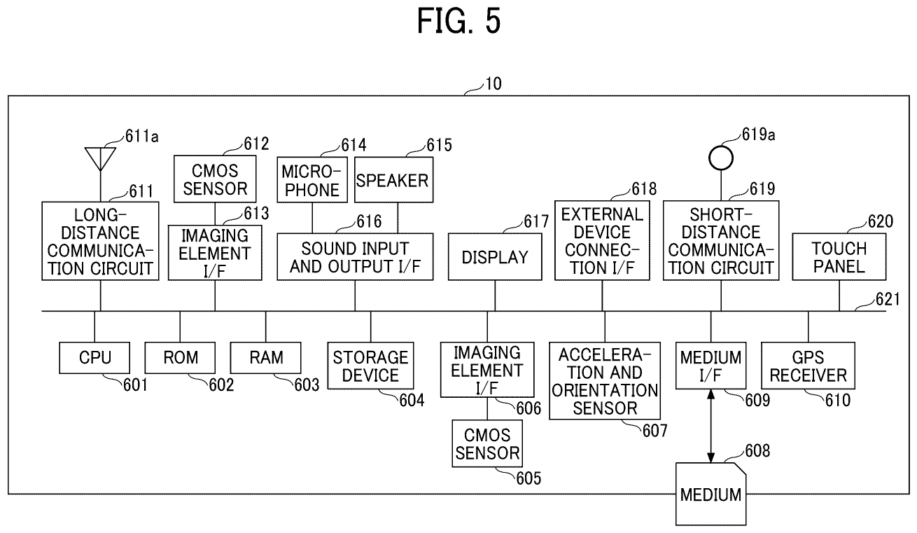

FIG. 5 is a diagram illustrating an example of a hardware configuration of the terminal apparatus 10. In the following description, an example of a hardware configuration of the terminal apparatus 10 in a case where the terminal apparatus 10 is an information terminal such as a smartphone or a tablet terminal will be described.

In the example illustrated in FIG. 5, the terminal apparatus 10 includes a CPU 601, a ROM 602, a RAM 603, a storage device 604, a CMOS sensor 605, an imaging element I/F 606, an acceleration and orientation sensor 607, a medium I/F 609, and a global positioning system (GPS) receiver 610.

The CPU 601 controls the entire operation of the terminal apparatus 10 by executing a predetermined program. The ROM 602 stores a program used for driving the CPU 601 such as an IPL. The RAM 603 is used as a work area for the CPU 601. The storage device 604 is a large-capacity storage device that stores, e.g., an OS, a program such as an application, and various types of data, and is implemented by, e.g., a solid state drive (SSD), or a flash ROM.

The CMOS sensor 605 is an example of a built-in imaging device that captures an object (e.g., a self-image of the user) under control of the CPU 601 to obtain image data. The terminal apparatus 10 may include an imaging device such as a CCD sensor instead of the CMOS sensor 605. The imaging element I/F 606 is a circuit that controls execution of the CMOS sensor 605. Examples of the acceleration and orientation sensor 607 include various types of sensors such as an electromagnetic compass for detecting geomagnetism, a gyrocompass, and an accelerometer. The medium I/F 609 controls reading or writing (storing) of data from or to a medium (storage medium) 608 such as a flash memory. The GPS receiver 610 receives a GPS signal (positioning signal) from a GPS satellite.

The terminal apparatus 10 further includes a long-distance communication circuit 611, an antenna 611a of the long-distance communication circuit 611, a CMOS sensor 612, an imaging element I/F 613, a microphone 614, a speaker 615, a sound input and output I/F 616, a display 617, an external device connection I/F 618, a short-distance communication circuit 619, an antenna 619a of the short-distance communication circuit 619, and a touch panel 620.

The long-distance communication circuit 611 is a circuit that enables the terminal apparatus 600 to communicate with other devices through the communication network N. The CMOS sensor 612 is an example of a built-in imaging device that captures an object under control of the CPU 601 to obtain image data. The imaging element I/F 613 is a circuit that controls execution of the CMOS sensor 612. The microphone 614 is a built-in circuit that converts sound into an electrical signal (audio signal). The speaker 615 is a built-in circuit that generates sound such as music or voice by converting an electrical signal into physical vibration. The sound input and output I/F 616 is a circuit that processes input and output of sound wave signals between the microphone 614 and the speaker 615 under control of the CPU 601.

The display 617 is an example of a display device such as a liquid crystal display or an organic electro luminescence (EL) display that displays, e.g., an image of the object and various icons. The external device connection I/F 618 is an interface for connecting the terminal apparatus 10 to various external devices. The short-distance communication circuit 619 includes a circuit that performs short-range wireless communication. The touch panel 620 is an example of an input device that allows a user to operate the terminal apparatus 10 by touching a screen of the display 617.

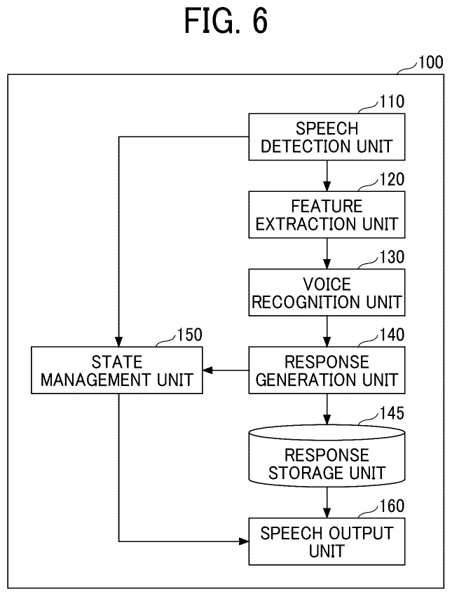

The terminal apparatus 10 further includes a bus line 621. The bus line 621 includes, e.g., an address bus or a data bus for electrically connecting the components such as the CPU 601 illustrated in FIG. 6 with each other.

The hardware configuration illustrated in FIG. 5 is merely one example. The terminal apparatus 10 may have another hardware configuration as long as the terminal apparatus 10 includes a processor, a communication circuit, a display, a microphone, and a speaker. Further, any one of the display, microphone, and speaker may be provided separately from the terminal apparatus 10, each of which may be connected with the terminal apparatus 10.

### Functional Configuration

FIG. 6 is a diagram illustrating an example of a functional configuration of the server apparatus 100 according to the first embodiment. As illustrated in FIG. 6, the server apparatus 100 includes a speech detection unit 110, a feature extraction unit 120, a voice recognition unit 130, a response generation unit 140, a response storage unit 145, a state management unit 150, and a speech output unit 160.

The speech detection unit 110, the feature extraction unit 120, the voice recognition unit 130, the response generation unit 140, the state management unit 150, and the speech output unit 160 are implemented by, e.g., processing executed by the CPU 501 that operates in cooperation with the network I/F 508 according to a program loaded from the ROM 502 to the RAM 503 illustrated in FIG. 4.

The response storage unit 145 is implemented by using, e.g., the HD 504 illustrated in FIG. 4. The reading and writing of data from and to the HD 504 are performed, e.g., under control of the HDD controller 505.

The speech detection unit 110 detects a speech made by the user 11 who uses the terminal apparatus 10. For example, the speech detection unit 110 detects a voiced section from the video (moving image and voice) of the user 11 received from the terminal apparatus 10 to acquire an acoustic signal indicating the voice spoken by the user 11. The voiced section may be detected by a technique such as voice activity detection (VAD). Accordingly, the speech detection unit 110 detects the start and end of the speech of the user 11. In the following description, the speech of the user 11 is referred to as a “user speech.” The user speech is an example of a first speech.

The feature extraction unit 120 extracts an acoustic feature value from the user speech detected by the speech detection unit 110. Any acoustic feature value may be any feature amount as long as voice recognition can be done using the feature amount.

The voice recognition unit 130 performs voice recognition on the user speech based on the acoustic feature value extracted by the feature extraction unit 120. The voice recognition unit 130 outputs text data indicating a voice recognition result.

The voice recognition unit 130 may use any voice recognition technology as long as the voice recognition technology can generate text data based on the acoustic feature value.

The response generation unit 140 generates a speech from the dialog agent for responding to the user speech based on the voice recognition result output by the voice recognition unit 130. The speech from the dialog agent may be only voice or may be video including voice. The video may include non-verbal information of the dialog agent. The non-verbal information may include, e.g., a physical action such as a facial expression, a gesture, or a hand gesture. In the following description, a speech for responding to a user speech is referred to as a “response speech.”

The response generation unit 140 may generate a response speech in cooperation with an external device or system. Examples of the external device or system include various search engines, a large language model (LLM), an image generation model, and a text to speech (TTS) system. The term “external” means that a device or system is not included in the dialog apparatus. The server apparatus 100 may communicate with the external device or system via the communication network N.

The response storage unit 145 stores speech from the dialog agent. The response storage unit 145 stores a plurality of turn-holding speeches generated in advance, a plurality of turn-transfer speeches generated in advance, and a response speech generated by the response generation unit 140. The response storage unit 145 may store information indicating behavior when the dialog agent outputs the turn-holding speech, the turn-transfer speech, and the response speech. The turn-holding speech and the turn-transfer speech are examples of speeches for facilitating a dialog with the user.

The turn-holding speech is a speech made by the dialog agent to hold a turn. In other words, the turn-holding speech is a speech for indicating to the user 11 that the current turn state is a system's turn. The turn-holding speech may include a first-turn holding speech, a second-turn holding speech, and a third-turn holding speech which are output under different conditions. The turn-holding speech is an example of a second speech.

The first-turn holding speech is a turn holding speech that is output before the response speech to the user speech and when the end of the user speech is detected. The first-turn holding speech may include a back channel. The back channel is a short speech, such as a nod or filler. The back channel may be a short speech such as “Let's see,” “Well,” or “I see”. When the dialog agent is an entity that performs visual representation, such as a virtual human, the back channel may include actions such as nodding, gesturing, or facial expressions.

The second-turn holding speech is a turn-holding speech output before the response speech to the user speech and after the first-turn holding speech. The second-turn holding speech may be generated by the response generation unit 140. The second-turn holding speech may include a speech indicating sympathy to the user 11 or mirroring. The mirroring is a speech for repeating the content of the user speech. The mirroring may be a speech for summarizing the user speech. The mirroring may be a speech for listening back to the content of the user speech. The mirroring may be generated by summarizing the voice recognition result of the user speech using an LLM, for example. When the dialog agent is an entity that performs visual representation, such as a virtual human, mirroring may include, e.g., an operation that mimics the operation of the user.

The third-turn holding speech is a turn-holding speech that is output before the response speech to the user speech and when the response generation unit 140 requires a predetermined processing time to generate a speech.

The third-turn holding speech is a speech for connecting between conversations in the dialog. The third-turn holding speech may include a back channel.

The turn-transfer speech is a speech made by the dialog agent to transfer the turn to the user 11. In other words, the turn-transfer speech is a speech for indicating to the user 11 that the current turn state is the user turn. The turn-transfer speech is a speech output before the response speech to the user speech and when the start of the user speech is detected. The turn-transfer speech may include, e.g., a speech for prompting the user 11 to make a speech. The speech for prompting the user 11 to make a speech may be, e.g., a speech for agreeing with the user 11. The speech for agreeing with the user 11 may be a positive speech such as “Yeah, yeah.” The turn-transfer speech may be, e.g., a question to the user 11. The question to the user 11 may be a short question such as “What's wrong?” The turn-transfer speech is another example of the second speech.

The state management unit 150 manages a turn state of the dialog between the user 11 and the dialog agent. The turn state may be information indicating whether the turn of the dialog is a turn of the user 11 (hereinafter, referred to as a “user turn”) or a turn of the dialog agent (hereinafter, referred to as a “system turn”). The turn means a right to speak. The speaker having the turn changes at any time in the course of the dialog. Each speaker may speak regardless of the presence or absence of the turn. However, when each speaker speaks when having a turn, the user 11 and the dialog agent have a smooth dialog.

The state management unit 150 may shift the turn state of the dialog based on a detection state of the user speech. The detection state of the user speech may be a state indicating whether the user speech is detected. The detection state of the user speech may be a state in which the user speech is detected during a period from when the speech detection unit 110 detects the start of the user speech to when the speech detection unit 110 detects the end of the user speech. The detection state of the user speech may be a state in which the user speech is not detected until the speech detection unit 110 detects the start of a new user speech after detecting the end of the user speech.

For example, when the state management unit 150 detects the start of the user speech when the turn state is the system turn, the state management unit 150 shifts the turn state to the user turn. For example, when the state management unit 150 detects the end of the user speech when the turn state is the user turn, the state management unit 150 shifts the turn state to the system turn.

The state management unit 150 may track the turn state of the dialog based on a response state to the user speech. The response state to the user speech may be a state indicating whether a response to the user speech has been made. For example, when the state management unit 150 ends the output of the response speech when the turn state is the system turn, the state management unit 150 shifts the turn state to the user turn.

The speech output unit 160 outputs a response from the dialog agent and a speech for facilitating a dialog with the user. The speech from the dialog agent may include a response speech, a turn-holding speech, and a turn-transfer speech. The speech output unit 160 may output the speech stored in the response storage unit 145.

The speech output unit 160 outputs a turn-holding speech or a turn-transfer speech when a predetermined condition is satisfied. The predetermined condition may be a condition related to a turn state managed by the state management unit 150. For example, the speech output unit 160 may output the first-turn holding speech when an end of the user speech is detected (in other words, when the turn state is shifted to the system tern). The dialog agent outputs the first-turn holding speech when the user ends the speech, and thus the user 11 recognizes that the turn of the dialog has been shifted to the dialog agent.

For example, the speech output unit 160 may output the second-turn holding speech when the response generation unit 140 is generating the response speech (in other words, when the turn state is the system turn). The dialog agent outputs the second-turn holding speech, and thus the user 11 recognizes that the dialog agent understands the user speech, and the sense of realism of the dialog is enhanced. In addition, when the response speech is generated based on an external device or system, the response waiting time of the user 11 due to the delay of the process is reduced. For example, when the voice of the response speech is synthesized using an external voice synthesis system and the number of characters of the text to be synthesized is large, the processing may take time.

For example, when the start of the user speech is detected in a case where the turn state is a system turn (in other words, when the turn state is shifted to the user turn), the speech output unit 160 may output a question to the user 11 as the turn-transfer speech. When the user 11 makes an interrupt speech while the dialog agent is making a speech with a turn or is about to make a speech, it is considered that the user 11 is about to make a speech of important content. In this case, the dialog is smoothly progressed by transferring the turn to the user 11 and prompting the user 11 to speak.

### Flow of Dialog

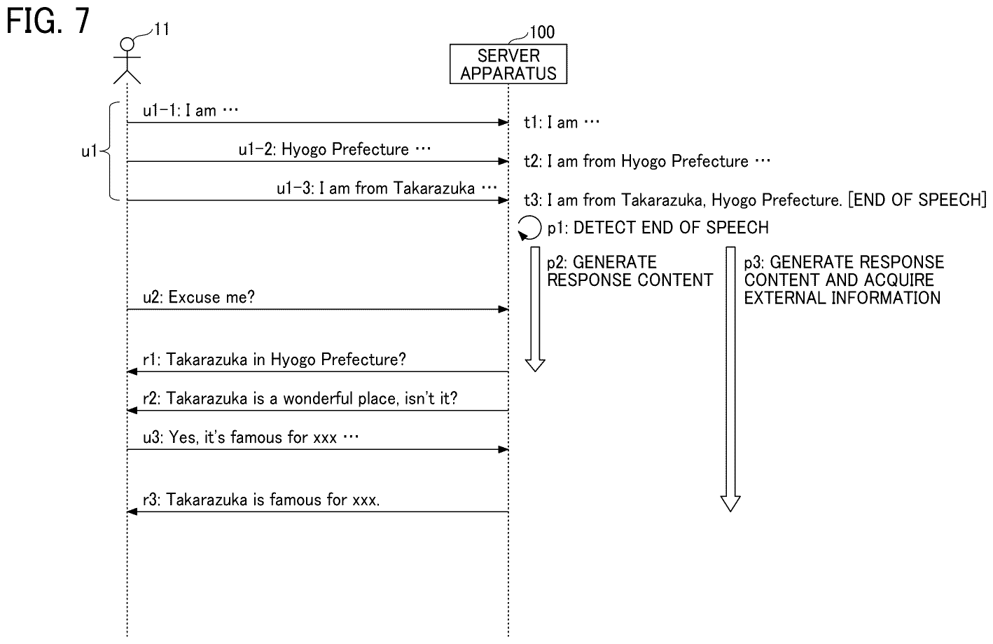

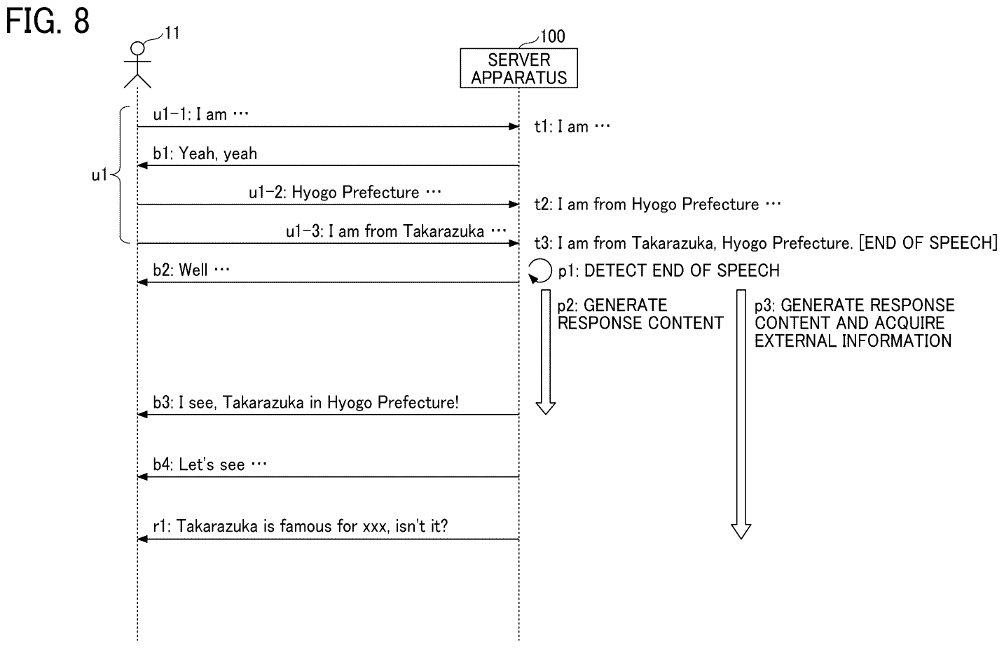

The flow of dialog between a comparative example and the present embodiment will be compared with reference to FIG. 7 and FIG. 8.

FIG. 7 is a sequence diagram illustrating an example of a flow of a dialog according to a comparative example. It is assumed that the user 11 performs a user speech u1 such as “I am from Takarazuka, Hyogo Prefecture.” The server apparatus 100 sequentially receives acoustic signals indicating user speeches u1, such as “I am (u1-1),” “Hyogo Prefecture (u1-2),” and “I am from Takarazuka (u1-3).” The server apparatus 100 sequentially performs voice recognition on the input user speeches u1-1, u1-2, and u1-3, thereby sequentially generating voice recognition progress t1 and t2 such as “I am” and “I am from Hyogo Prefecture,” and finally obtaining a voice recognition result t3 such as “I am from Takarazuka, Hyogo Prefecture.”

When the end of the user speech u1 is detected (p1), the server apparatus 100 generates a response speech to the user speech u1 based on the voice recognition result t3 of the entire user speech u1 (p2). The server apparatus 100 may acquire external information together with the generation of the response speech (p3).

However, the generation of the response speech (p2) and the acquisition of the external information (p3) require a predetermined processing time. Therefore, even when the end of the user speech u1 is detected, the dialog system according to the comparative example does not respond until the generation of the response speech is completed. In this case, the user 11 cannot understand the state of the dialog system, and performs a user speech u2 such as “Excuse me?”

When the generation of the response speech (p2) is ended, the dialog agent outputs response speeches “Takarazuka in Hyogo Prefecture?” and “Takarazuka is a wonderful place, isn't it?” as r1 and r2. In response to the response speeches r1 and r2, the user 11 may attempt to continue the dialog with a user speech u3 such as “Yes, it's famous for xxx.” However, when the acquisition (p3) of the external information is completed, the dialog agent outputs a response speech r3 such as “Takarazuka is famous for xxx.” based on the external information. In this case, the dialog between the user 11 and the dialog agent is not engaged, and the dialog breaks down.

In order to solve the problem illustrated in FIG. 7, when the end of the user speech u1 is detected, a sound (e.g., a beep sound) indicating that the user speech is received may be output when the end of the user speech u1 is detected. However, when a sound such as a beep sound is output during the dialog, the sense of realism of the dialog is impaired, which is not preferable. In addition, for example, a dialog system that outputs a response such as laughter or nodding to the user speech u1 is proposed. However, the response is intended to present sympathy to the user 11, and does not have a function of causing the user 11 to recognize a turn.

FIG. 8 is a sequence diagram illustrating an example of a flow of a dialog according to the first embodiment. When the dialog agent detects the start of a user speech u1, the dialog agent outputs a turn-transfer speech b1 such as “Yeah, yeah.” In addition, when the dialog agent detects the end of the user speech u1 (p1), the dialog agent outputs a first-turn holding speech b2 such as “Well.”

When the user 11 makes the user speech u1 and is responded with the turn-transfer speech b1, the user 11 recognizes that the dialog agent is in a state of waiting for the user speech u1. In other words, the user 11 recognizes that the user 11 has a turn by the first-turn-transfer speech b1. The user 11 continues the speech without anxiety because the user 11 is in his or her turn.

When the user 11 receives a response with the first-turn holding speech b2 after the user 11 makes the user speech u1, the user 11 recognizes that the dialog agent is in a state of receiving the user speech u1 and preparing for the response. In other words, the user 11 recognizes that the dialog agent has a turn by the first-turn holding speech b2. The user 11 refrains from speaking until the dialog agent responds to the user speech u1, and thus a breakdown of the dialog is avoided.

When a predetermined processing time is required for the generation (p2) of the response speech, the dialog agent may output a second-turn holding speech b3 including a back channel such as “I see” or mirroring such as “Takarazuka in Hyogo Prefecture!” In addition, when a predetermined processing time is required for the acquisition (p3) of the external information, the dialog agent may output a third-turn holding speech b4 such as “Let's see”

Since the user 11 recognizes that the dialog agent has a turn from the first-turn holding speech b2, the user 11 recognizes that the turn of the dialog agent is continued from the second-turn holding speech b3 and the third-turn holding speech b4. Since the user 11 refrains from speech until the dialog agent outputs a subsequent response, a breakdown of the dialog is avoided even when it takes time to generate (p2) a response speech or to acquire (p3) external information.

Although FIG. 8 illustrates an example in which the dialog agent outputs the short back channels b1, b2, b3, and b4, the dialog agent may output a response including a gesture. Examples of the gesture include taking the user's line of sight off, starting to move the hand, and smiling.

As illustrated in FIG. 8, the dialog system 1 returns the turn-holding speech or the turn-transferring speech to the user 11 while processing the user speech u1, and thus the turn taking between the user 11 and the dialog agent becomes smooth. This prevents the user 11 from interrupting the dialog during the processing performed by the dialog system 1. At this time, an appropriate back channel that does not make the user 11 uncomfortable may be returned by analyzing acoustic features in parallel in accordance with the voice recognition process or the length of the user speech.

As described above, according to the present embodiment, the turn taking between the user 11 and the dialog agent becomes smooth. For example, in the application of, e.g., a nursing care or counseling application, listening effects are enhanced. In addition, in the application of, e.g., business negotiation, the customer's speech is enhanced.

### Processing Procedure

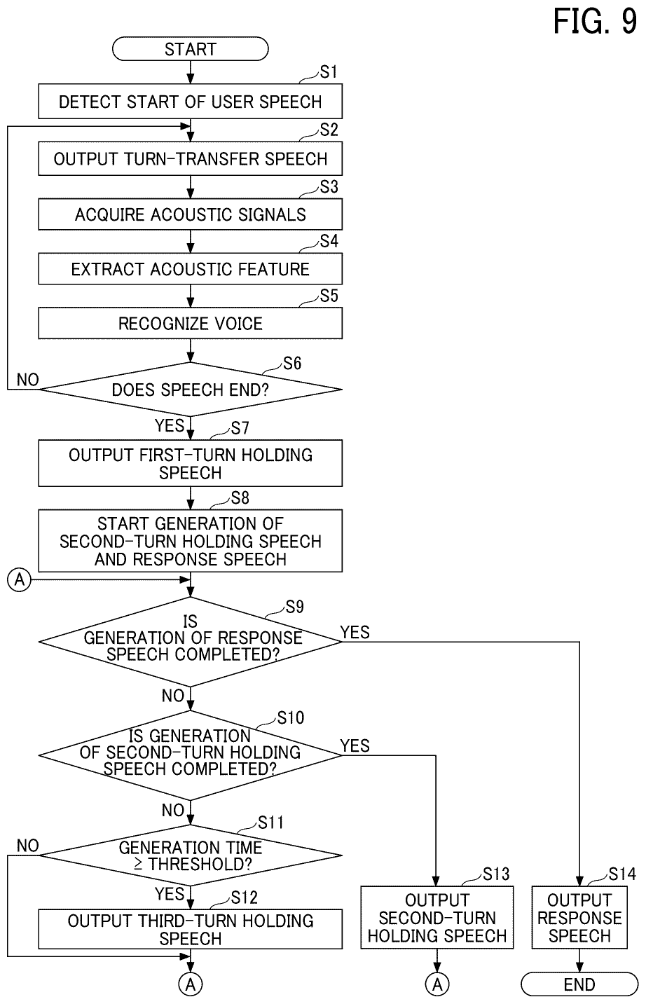

FIG. 9 is a flowchart illustrating an example of a dialog method according to the first embodiment. The dialog method is a processing procedure from a speech of the user to a response of the dialog agent. Accordingly, the dialog method is repeatedly executed while the dialog between the user and the dialog agent continues.

In step S1, the speech detection unit 110 of the server apparatus 100 detects the start of the user speech. When the speech detection unit 110 detects the user speech, the state management unit 150 shifts the turn state to the user turn.

In step S2, the speech output unit 160 of the server apparatus 100 reads a turn-transfer speech from the response storage unit 145. The speech output unit 160 may randomly select one turn-transfer speech from the turn-transfer speeches stored in the response storage unit 145. The speech output unit 160 may read information indicating a behavior when the turn-transfer speech is output together with the turn-transfer speech.

The speech output unit 160 controls the dialog agent to output the read turn-transfer speech from the dialog agent. The speech output unit 160 may output the turn-transfer speech only when a predetermined condition is satisfied. For example, the speech output unit 160 may perform control of the dialog agent to output the turn-transfer speech only once every time the user speech is detected a predetermined number of times.

In step S3, the speech detection unit 110 of the server apparatus 100 acquires an acoustic signal indicating a user speech. The speech detection unit 110 transmits the acoustic signal indicating the user speech to the feature extraction unit 120.

In step S4, the feature extraction unit 120 of the server apparatus 100 receives the acoustic signal from the speech detection unit 110. The feature extraction unit 120 extracts an acoustic feature value from the received acoustic signal. The feature extraction unit 120 transmits the extracted acoustic feature value to the voice recognition unit 130.

In step S5, the voice recognition unit 130 of the server apparatus 100 receives the acoustic feature value from the feature extraction unit 120. The voice recognition unit 130 performs voice recognition on the user speech based on the received acoustic feature value. The voice recognition unit 130 transmits the voice recognition result to the response generation unit 140.

In step S6, the speech detection unit 110 of the server apparatus 100 determines whether the end of the user speech has been detected. When the end of the user speech is detected (YES at step S6), the speech detection unit 110 proceeds the process to step S7. At this time, the speech detection unit 110 notifies the state management unit 150 and the speech output unit 160 of the end of the user speech.

On the other hand, when the end of the user speech is not detected (NO at step S6), the speech detection unit 110 returns the process to step S2. After returning to step S2, the speech detection unit 110 acquires the next acoustic signal to transmit the acquired acoustic signal to the feature extraction unit 120. The feature extraction unit 120 receives the next acoustic signal from the speech detection unit 110 to extract an acoustic feature value from the received acoustic signal. In this way, the server apparatus 100 repeatedly executes the processing from step S2 to step S6 until the end of the user speech is detected.

In step S7, the state management unit 150 of the server apparatus 100 shifts the turn state to the system turn in response to the notification from the speech detection unit 110. The speech output unit 160 reads the first-turn holding speech from the response storage unit 145 in response to the shift of the turn state to the system turn. The speech output unit 160 may randomly select one first-turn holding speech from the first-turn holding speeches stored in the response storage unit 145. The speech output unit 160 may read information indicating a behavior when the first-turn holding speech is output together with the first-turn holding speech. The speech output unit 160 controls the dialog agent to output the read first-turn holding speech from the dialog agent.

In step S8, the response generation unit 140 of the server apparatus 100 receives the voice recognition result from the voice recognition unit 130. The response generation unit 140 starts generating the second-turn holding speech and the response speech based on the received voice recognition result.

In step S9, the response generation unit 140 of the server apparatus 100 determines whether the generation of the response speech is completed. When the generation of the response speech is completed (YES at step S9), the response generation unit 140 stores the response speech in the response storage unit 145, and the process proceeds to step S14. On the other hand, when the generation of the response speech is not completed (NO at step S9), the response generation unit 140 proceeds the process to step S10.

In step S10, the response generation unit 140 of the server apparatus 100 determines whether the generation of the second-turn holding speech has been completed. When the generation of the second-turn holding speech is completed (YES at step S10), the response generation unit 140 stores the second-turn holding speech in the response storage unit 145, and the process proceeds to step S13. On the other hand, when the generation of the second-turn holding speech is not completed (NO at step S10), the response generation unit 140 transmits a generation time of the response speech to the speech output unit 160, and the process proceeds to step S11. The generation time of the response speech is the elapsed time from the start of the generation of the response speech in step S8.

In step S11, the speech output unit 160 of the server apparatus 100 receives the generation time of the response speech from the response generating unit 140. The speech output unit 160 determines whether the generation time of the response speech is equal to or more than a predetermined threshold. When the generation time of the response speech is equal to or more than the predetermined threshold (YES at step S11), the speech output unit 160 proceeds the process to step S12. On the other hand, when the generation time of the response speech is less than the predetermined threshold (NO at step S11), the speech output unit 160 skips step S12 and returns the process to step S9.

In step S12, the speech output unit 160 of the server apparatus 100 reads the third-turn holding speech from the response storage unit 145. The speech output unit 160 may randomly select one third-turn holding speech from the third-turn holding speeches stored in the response storage unit 145. The speech output unit 160 may read information indicating a behavior when the third-turn holding speech is output together with the third-turn holding speech. The speech output unit 160 controls the dialog agent to output the read third-turn holding speech from the dialog agent. After outputting the third-turn holding speech, the speech output unit 160 returns the process to step S9.

In step S13, the speech output unit 160 of the server apparatus 100 receives the second-turn holding speech from the response generating unit 140. The speech output unit 160 controls the dialog agent to output the received second-turn holding speech from the dialog agent. After outputting the second-turn holding speech, the speech output unit 160 returns the process to step S9.

In step S14, the speech output unit 160 of the server apparatus 100 reads the response speech from the response storage unit 145. The speech output unit 160 controls the dialog agent to output the read response speech from the dialog agent. When the output of the response speech is ended, the speech output unit 160 notifies the state management unit 150 of the end of the response speech. The state management unit 150 shifts the turn state to the user turn in response to the notification from the speech output unit 160.

The server apparatus 100 according to the first embodiment outputs the second speech for facilitating a dialog with the user before outputting the response speech from the dialog agent in response to the content of the first speech of the user. The second speech may include a speech for holding a turn or a speech for transferring a turn.

The second speech for facilitating the dialog is a nonverbal or verbal reaction or signal that the listener performs to the speaker in order to, e.g., present interest or understanding or prompt the speaker to continue further speaking in the communication through the dialog. By outputting the second speech for facilitating the dialog from the dialog agent to the user, the dialog between the dialog agent and the user proceeds smoothly, and effective communication between the dialog agent and the user is enhanced. Accordingly, in one aspect, the dialog with the user proceeds smoothly with the user using the dialog agent.

When the end of the user speech is detected, the server apparatus 100 may shift the turn state to the system turn. The server apparatus 100 may output the second speech when the turn state is shifted to the system turn. The user recognizes that the turn state is shifted to the system turn, by the second speech being output from the dialog agent when the speech is ended. According to the present embodiment, the user is indicated that the turn state is the system turn.

In a case where the server apparatus 100 detects a user speech when the turn state is the system turn, the server apparatus 100 may shift the turn state to the user turn. The server apparatus 100 may output a turn-transfer speech when the turn state shifts to the user turn. The user recognizes that the turn is the user turn, by the turn-transfer speech being output from the dialog agent when the user starts the speech. According to the present embodiment, the user is indicated that the turn state is the user turn.

The server apparatus 100 may generate a response speech to the user speech based on the voice recognition result obtained by recognizing the user speech. The server apparatus 100 may output a second-turn holding speech for summarizing the voice recognition result when the server apparatus 100 is generating the response speech. The user recognizes that the dialog agent understands the user speech, by the dialog agent speaking the summary of the user speech. According to the present embodiment, the sense of realism of the dialog is enhanced, and the response time that the user waits for is reduced.

The server apparatus 100 may output the third-turn holding speech when the generation time of the response speech exceeds the threshold. The user recognizes that the dialog agent is about to speak, by the third-turn holding speech being output from the dialog agent when the response waiting time is long. According to the present embodiment, the response time that the user waits for is reduced.

### Second Embodiment

In the first embodiment, the configuration has been described in which the turn state is shifted to the user turn when the speech detection unit 110 detects the user speech. For example, when the server apparatus 100 is generating a response speech, the user may forcibly interrupt the dialog in order to, e.g., correct the speech. This user speech is important because of its high message property. Accordingly, the server apparatus 100 may shift the turn state to the user turn even during the generation of the response speech. However, when the turn state is shifted to the user turn in response to the detection of the user speech, the user's voice that should be ignored, such as coughing or noise, is recognized as an important message. This may cause a breakdown of the dialog.

In the second embodiment, when the speech detection unit 110 detects a user speech, whether to enable an interruption is determined. Specifically, the speech detection unit 110 determines whether to shift the turn state to the user turn based on the voice recognition result of the user speech and the time length of the user speech. For example, the speech detection unit 110 may not shift the turn state to the user turn when the voice recognition result indicates a speech not intended for speaker change such as coughing or a filler. In addition, the speech detection unit 110 may not shift the turn state to the user turn when the time length of the user speech is equal to or less than a predetermined threshold.

On the other hand, for example, when the voice recognition result is not, e.g., coughing or a filler and the time length of the user speech exceeds a predetermined threshold, the speech detection unit 110 may shift the turn state to the user turn. In this case, the speech output unit 160 may output the turn-transfer speech when the speech detection unit 110 has shifted to the user turn. The user can continue the speech with peace of mind because the user recognizes that the turn of the dialog has returned to the user.

### Speech Detection Processing

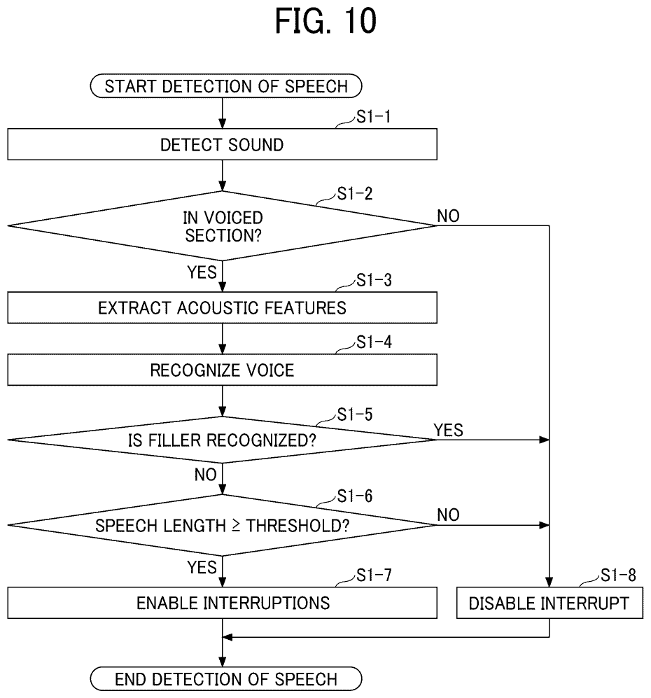

FIG. 10 is a flowchart illustrating an example of speech detection processing according to the second embodiment. The speech detection processing corresponds to step S1 illustrated in FIG. 9.

In step S1-1, the speech detection unit 110 detects a sound from the video of the user 11 received from the terminal apparatus 10. The speech detection unit 110 may detect a sound based on, e.g., a waveform of an acoustic signal included in the video of the user 11. The speech detection unit 110 acquires an acoustic signal including the detected sound.

In step S1-2, the speech detection unit 110 determines whether the acoustic signal acquired in step S1-1 is in a voiced section. For example, when a voice detection technique such as VAD is used, it is possible to determine whether a voice is included in the acoustic signal.

When the acoustic signal is in a voiced section (YES at step S1-2), the speech detection unit 110 transmits the acoustic signal of the voiced section to the feature extraction unit 120, and the process proceeds to step S1-3. On the other hand, in a case where the acoustic signal is not a voiced section (NO at step S1-2), the speech detection unit 110 proceeds the process to step S1-8.

In step S1-3, the feature extraction unit 120 receives the acoustic signal in the voiced section from the speech detection unit 110. The feature extraction unit 120 extracts an acoustic feature value from the acoustic signal in the voiced section. The feature extraction unit 120 transmits the extracted acoustic feature value to the voice recognition unit 130.

In step S1-4, the voice recognition unit 130 receives the acoustic feature value from the feature extraction unit 120. The voice recognition unit 130 performs voice recognition based on the received acoustic feature value. The voice recognition unit 130 transmits a voice recognition result to the speech detection unit 110.

In step S1-5, the speech detection unit 110 receives the voice recognition result from the voice recognition unit 130. The speech detection unit 110 determines whether a filler is recognized based on the received voice recognition result.

When the filler is recognized (YES at step S1-5), the speech detection unit 110 proceeds the process to step S1-8. On the other hand, when the filler is not recognized (NO at step S1-5), the speech detection unit 110 proceeds the process to step S1-6.

In step S1-6, the speech detection unit 110 determines whether the speech length of the voiced section is equal to or longer than a predetermined value. The speech length may be, e.g., the number of characters in the voice recognition result or the speech time in the acoustic signal.

When the speech length is equal to or greater than the threshold (YES at step S1-6), the speech detection unit 110 proceeds the process to step S1-7. On the other hand, when the speech length is less than the threshold (NO at step S1-6), the speech detection unit 110 proceeds the process to step S1-8.

In step S1-7, the speech detection unit 110 enables an interruption. Specifically, the speech detection unit 110 notifies the state management unit 150 that the user speech is detected. The state management unit 150 shifts the turn state to the user turn.

In step S1-8, the speech detection unit 110 disables an interruption. In this case, the speech detection unit 110 discards the user speech and ends the process.

The server apparatus 100 according to the second embodiment determines whether the user speech is detected based on the voice recognition result of recognizing the user speech and the time length of the user speech. In one aspect, according to the present embodiment, even when a response speech is being generated, the turn state may shift to the user turn when the user makes an important speech.

For example, in applications such as nursing care, business negotiation, and counseling, when interruption to a dialog is possible, the user does not have to wait for a speech from a dialog agent, and may smoothly lead the dialog. On the other hand, the turn state does not shift to the user turn by a speech that should be ignored, such as coughing or a filler, and thus a breakdown of the dialog is avoided.

### Third Embodiment

In the first embodiment, the configuration has been described in which the speech output unit 160 outputs a predetermined or random back channel. In the third embodiment, a configuration for outputting a back channel corresponding to the user's emotion will be described. By outputting the back channel based on the user's emotion, a highly cooperative dialog that is in line with the user's emotion is realized.

### Functional Configuration

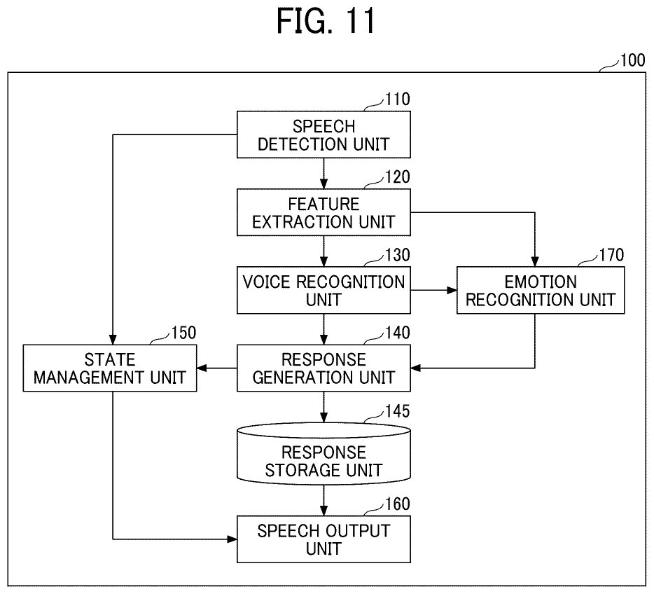

FIG. 11 is a diagram illustrating an example of a functional configuration of a server apparatus according to the third embodiment. As illustrated in FIG. 11, the server apparatus 100 according to the present embodiment includes the speech detection unit 110, the feature extraction unit 120, the voice recognition unit 130, the response generation unit 140, the response storage unit 145, the state management unit 150, the speech output unit 160, and an emotion recognition unit 170. The server apparatus 100 according to the third embodiment is different from the server apparatus 100 according to the first embodiment in that the server apparatus 100 according to the third embodiment further includes the emotion recognition unit 170.

The emotion recognition unit 170 recognizes the user's emotion based on the user speech. The emotion recognition unit 170 may recognize the user's emotion based on the voice recognition result obtained by recognizing the user speech. The emotion recognition unit 170 may recognize the user's emotion based on the acoustic feature value extracted from the user speech. The emotion recognition unit 170 may recognize the user's emotion based on both the voice recognition result and the acoustic feature value. In the present embodiment, an example of recognizing the user's emotion based on both the voice recognition result and the acoustic feature value will be described.

For example, the emotion recognition unit 170 may classify the acoustic feature value into any one of a plurality of emotions based on a learned classification model. The emotion recognition unit 170 may classify the voice recognition result into any of a plurality of emotions based on, e.g., an LLM. The emotion classification may be, e.g., a ternary classification of positive, negative, and neutral. The positive is a positive emotion represented by “joy.” The negative is a negative emotion represented by “sadness.” The neutral is an emotion other than positive and negative.

The emotion recognition unit 170 may determine a final emotion recognition result based on a combination of the emotion recognition result based on the acoustic feature value and the emotion recognition result based on the voice recognition result. The emotion recognition unit 170 may determine a final emotion recognition result based on a predetermined emotion determination rule.

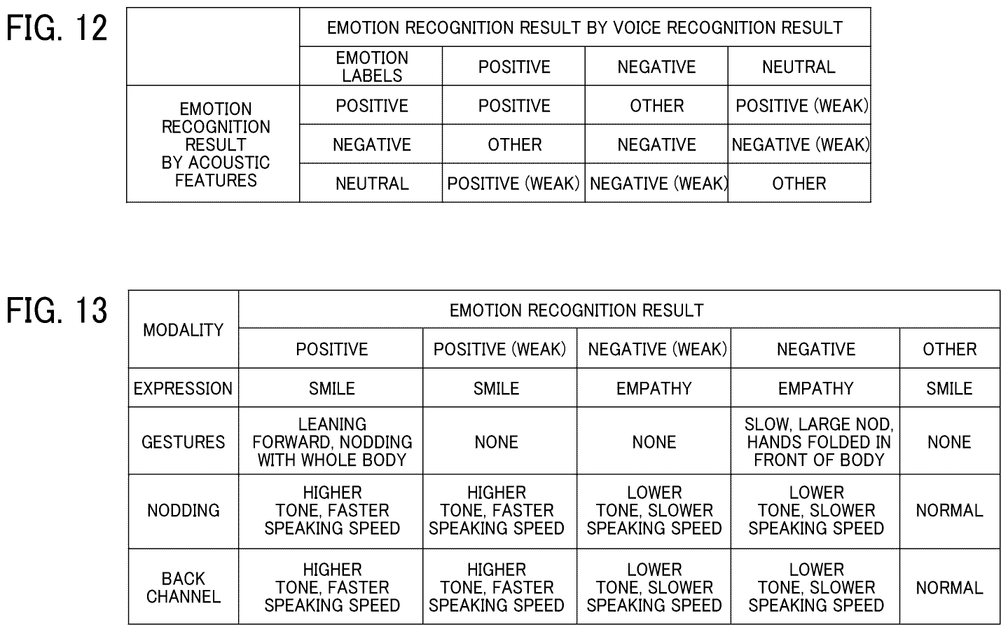

FIG. 12 is a diagram illustrating an example of the emotion determining rule according to the third embodiment. As illustrated in FIG. 12, the emotion determining rule is a rule for determining a final emotion recognition result for a combination of an emotion recognition result based on an acoustic feature value and an emotion recognition result based on a voice recognition result.

For example, when both emotion recognition results are positive or negative, the final emotion recognition result is also positive or negative. For example, if one emotion recognition result is positive or negative and the other emotion recognition result is neutral, the final emotion recognition result is weakly positive or weakly negative. For example, when the emotion recognition result is a combination of positive and negative or both emotion recognition results are neutral, the final emotion recognition result is other.

In the present embodiment, the speech output unit 160 outputs the first-turn holding speech based on the emotion recognition result obtained by the emotion recognition unit 170 recognizing the user's emotion. For example, the speech output unit 160 may output the first-turn holding speech in a behavior corresponding to the emotion recognition result. The speech output unit 160 may determine the behavior when the first-turn holding speech is output, based on a predetermined behavior determination rule.

FIG. 13 is a diagram illustrating an example of a behavior determination rule according to the third embodiment. As illustrated in FIG. 13, the behavior determination rule is a rule for determining the behavior of the dialog agent with respect to the emotion recognition result. The behavior of the dialog agent may include various modalities.

The modality may include, e.g., a facial expression, a gesture, a nod, a voice pitch, and a speech rate.

For example, when the emotion recognition result is positive, weakly positive, or other, the facial expression of the dialog agent may be smiling. The facial expression for the smiling may be, e.g., a facial expression in which the mouth angle is raised and the corner of the eye is lowered. On the other hand, when the emotion recognition result is negative or weakly negative, the facial expression of the dialog agent may be set to a sympathy expression. The facial expression for sympathy may be, e.g., a facial expression for seriously listening to a dialog. The negative is a facial emotion represented by “sadness,” but may not be a facial expression indicating sadness.

### Processing Procedure

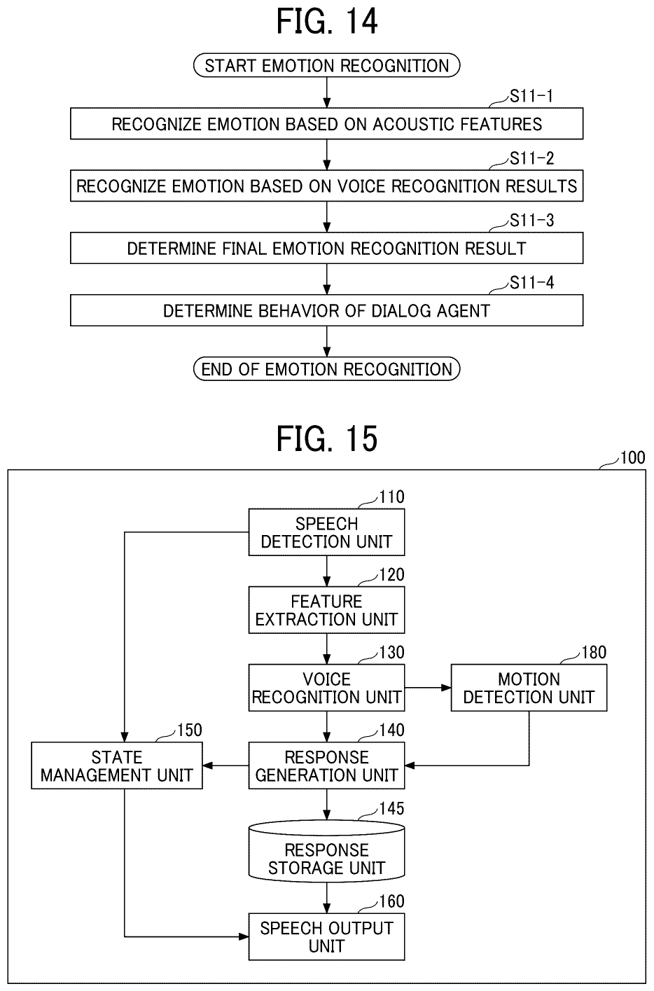

FIG. 14 is a flowchart illustrating an example of the facial emotion recognition processing according to the third embodiment. The facial emotion recognition processing may be executed before the first-turn holding speech is output, and may be executed between, e.g., step S6 and step S7.

In step S11-1, the emotion recognition unit 170 recognizes the user's emotion based on the acoustic feature value extracted by the feature extraction unit 120. Specifically, the emotion recognition unit 170 classifies the voice recognition result into any one of positive, negative, and neutral based on the learned classification model.

In step S11-2, the emotion recognition unit 170 recognizes the user's emotion based on the voice recognition result recognized by the voice recognition unit 130. Specifically, the emotion recognition unit 170 classifies the voice recognition result into positive, negative, or neutral based on an LLM.

In step S11-3, the emotion recognition unit 170 determines a final emotion recognition result based on a combination of the emotion recognition result recognized in step S11-1 and the emotion recognition result recognized in step S11-2. Specifically, the emotion recognition unit 170 determines a final emotion recognition result from a combination of emotion recognition results in accordance with the emotion determination rule.

In step S11-4, the emotion recognition unit 170 transmits the emotion recognition result determined in step S11-3 to the speech output unit 160. The speech output unit 160 determines the behavior of the dialog agent based on the emotion recognition result received from the emotion recognition unit 170. Specifically, the emotion recognition unit 170 determines the behavior of the dialog agent from the emotion recognition result in accordance with the behavior determination rule.

The server apparatus 100 according to the third embodiment recognizes the emotion of the user based on the user speech to output the first-turn holding speech corresponding to the recognition result of the emotion. In one aspect, according to the present embodiment, a speech that matches the user's emotion is output.

The server apparatus 100 may recognize the user's emotion based on the acoustic feature value extracted from the user speech and the voice recognition result obtained by recognizing the user speech. According to the present embodiment, the user's emotion is recognized in detail and accurately by recognizing the emotion based on both the acoustic feature and the content of the speech.

For example, in applications such as nursing care and counseling, the dialog agent enhances the listening effect by expressing an emotion close to the user's emotion. Additionally, in the application of, e.g., business negotiation, the understanding by the customer is enhanced.

### Fourth Embodiment

In the first embodiment, the configuration has been described in which the speech output unit 160 outputs a predetermined or random back channel. In the fourth embodiment, a configuration in which the dialog agent operates in accordance with a user's operation instead of the back channel will be described.

In a dialog between humans, for example, when a speaker laughs, a dialog partner may return a laugh even if the dialog partner is not interested. This is because laughing during a dialog by a human includes social implications such as inducing laughter or exciting the dialog. The behavior of the dialog partner laughing back when the speaker laughs is important communication. Therefore, to implement the same operation in a dialog system is desirable. However, even if the dialog system detects the laughter of the user, it is not easily realized that a dialog system laughs back in accordance with the laughter.

In the present embodiment, the voice recognition of the user speech is sequentially performed to detect laughter from the voice recognition result. When detecting a laughter, the dialog system outputs, e.g., a short laughter, a smile, or a gesture of sharing the laughter. This generates the sense of realism in which the dialog system is listening to the user speech in a friendly manner to establish a good relationship between the user and the dialog system.

Although laughter has been mainly described here, the present embodiment may be applied to any operation performed by the user. Since a human tends to have a sense of affinity with a partner who performs the same action as oneself, the dialog agent contributes to the establishment of a favorable relationship when the dialog agent performs an action close to the action of the user.

### Functional Configuration

FIG. 15 is a diagram illustrating an example of a functional configuration of the server apparatus 100 according to the fourth embodiment. As illustrated in FIG. 15, the server apparatus 100 according to the present embodiment includes the speech detection unit 110, the feature extraction unit 120, the voice recognition unit 130, the response generation unit 140, the response storage unit 145, the state management unit 150, the speech output unit 160, and an motion detection unit 180. The server apparatus 100 according to the fourth embodiment is different from the server apparatus 100 according to the first embodiment in that the server apparatus 100 according to the fourth embodiment further includes the motion detection unit 180.

The motion detection unit 180 detects a motion of the user. The motion detection unit 180 may detect the motion of the user based on the voice recognition result of the user speech. The motion detection unit 180 may detect the motion of the user by extracting a label indicating the motion of the user included in the voice recognition result.

The motion detection unit 180 may determine a degree of the detected motion. The degree of the motion may be, e.g., various laughter such as smiling, laughing with a loud voice, and laughing with a shaking body. For example, the motion detection unit 180 may determine the degree of the motion by classifying the degree of the motion based on a learned classification model. The classification model may be learned to receive the acoustic feature value as an input and output the label indicating the degree of the motion. Examples of the classification model include a support vector machine (SVM).

### Flow of Dialog

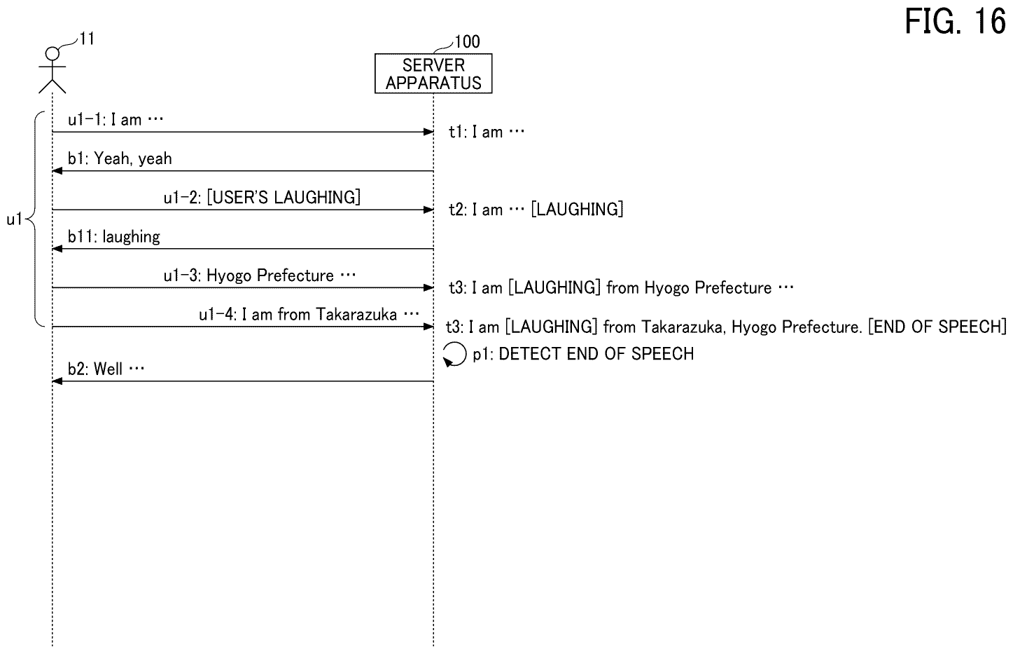

FIG. 16 is a sequence diagram illustrating an example of a flow of a dialog according to the fourth embodiment. It is assumed that the user 11 smiles briefly between “I am” and “Takarazuka Prefecture” when the user 11 makes a user speech u1 such as “I am from Hyogo Prefecture.” The server apparatus 100 recognizes that the user 11 has laughed to generate a voice recognition progress t2 such as “I am [laughing].”

The server apparatus 100 detects “laughing” included in the voice recognition progress t2 to output a laughing b11. The user 11 thinks that the dialog agent laughs back in response to his or her laughter, and has a sense of affinity with the dialog agent. As a result, a favorable relationship is established between the user 11 and the dialog agent, and the user smoothly proceeds with the subsequent dialog, e.g., the user 11 can easily speak to the dialog agent, or the user 11 can easily express the emotion in the dialog.

### Processing Procedure

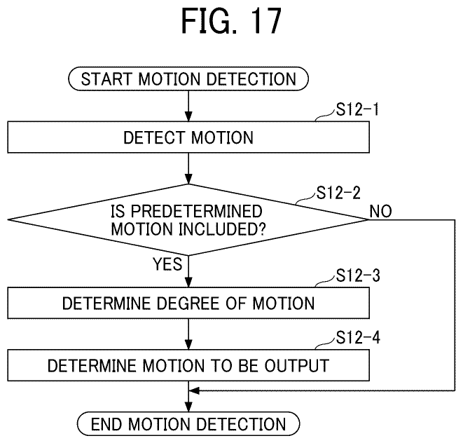

FIG. 17 is a flowchart illustrating an example of the motion detection processing according to the fourth embodiment. The motion detection processing may be executed before the end of the user speech is detected (in other words, when the turn state is the user turn), and may be executed, e.g., between step S5 and step S6.

In step S12-1, the motion detection unit 180 detects a user's motion. Specifically, the motion detection unit 180 extracts a label indicating a motion from the voice recognition result recognized by the voice recognition unit 130.

In step S12-2, the motion detection unit 180 determines whether a predetermined motion has been detected. The predetermined motion may be, e.g., laughing. When the predetermined motion is detected (YES at step S12-2), the motion detection unit 180 proceeds the process to step S12-3. On the other hand, when the predetermined motion is not detected (NO at step S12-2), the motion detection unit 180 ends the motion detection processing.

In step S12-3, the motion detection unit 180 determines the degree of the detected motion.

Specifically, the acoustic feature value of the voiced section in which the predetermined motion is detected is input to the learned classification model, and thus the label indicating the degree of the motion is acquired.

In step S12-4, the motion detection unit 180 notifies the speech output unit 160 of the motion determined in step S12-3. The speech output unit 160 determines the operation of the dialog agent in accordance with the notification from the motion detection unit 180.

The server apparatus 100 according to the fourth embodiment detects an action by the user to output an action according to the detection result of the action by the user from the dialog agent when the turn state is the user turn. In one aspect, a favorable relationship between the user and the dialog agent is established, and the dialog proceeds smoothly.

For example, in applications such as nursing care and counseling, the sense of distance between the dialog agent and the user is reduced.

Each of the functions of the above-described embodiments of the present disclosure may be implemented by one or more pieces of processing circuitry. The “processing circuitry” in the present disclosure includes a programmed processor to execute each function by software, such as a processor implemented by an electronic circuit, and devices such as application-specific integrated circuits (ASICs), a digital signal processor (DSP), field-programmable gate arrays (FPGAs), and conventional circuit modules arranged to perform the functions of the above-described embodiments.

The apparatuses or devices described in one or more embodiments are just one example of plural computing environments that implement the one or more embodiments disclosed herein. In some embodiments, the server apparatus 100 includes multiple computing devices, such as server clusters. The multiple computing devices communicates with one another through any selected type of communication link including a network and a shared memory to perform the processes disclosed herein.

The functional configuration of the server apparatus 100 may be integrated into one server apparatus or may be divided into a plurality of apparatuses. Furthermore, at least a part of the functional configurations of the server apparatus 100 may be included in the terminal apparatus 10.

In the related art, smooth dialog with the user may be hindered. For example, in the related art, how to output a response in a dialog and, e.g., a back channel for smoothing the dialog is not considered, and thus the dialog agent may not perform a dialog at an appropriate timing.

In view of the above technical problems, an object of an embodiment of the present disclosure is to smoothly interact with a user using a dialog agent.

According to an embodiment of the present disclosure, a dialog with a user may be smoothly performed using a dialog agent.

Some aspects of the present disclosure are described below.

### Aspect 1

A dialog apparatus responds to a speech of a user using a dialog agent. The dialog apparatus includes a speech detection unit and a speech output unit.

The speech detection unit detects a first speech of the user.

The speech output unit controls the dialog agent to output a response to the first speech detected by the speech detection unit.

When a predetermined condition is satisfied, the speech output unit controls the dialog agent to output a second speech for facilitating a dialog with the user before outputting the response.

### Aspect 2

In the dialog apparatus according to Aspect 1, the second speech includes a speech for holding a turn or a speech for transferring a turn.

### Aspect 3

The dialog apparatus according to Aspect 2 further includes a state management unit. The state management unit manages a turn state of the dialog based on a detection state of the first speech.

The speech output unit outputs the second speech based on the predetermined condition related to the turn state.

### Aspect 4

In the dialog apparatus according to Aspect 3, the state management unit shifts the turn state to the turn of the dialog agent when an end of the first speech is detected.

The speech output unit outputs the second speech for holding a turn when the turn state is shifted to a turn of the dialog agent.

### Aspect 5

In the dialog apparatus according to Aspect 3, the state management unit shifts the turn state to the user turn in a case where the first speech is detected when the turn state is the turn of the dialog agent.

The speech output unit outputs the second speech for transferring the turn when the turn state is shifted to the user turn.

### Aspect 6

In the dialog apparatus according to any one of Aspects 1 to 5, the speech detection unit determines whether the first speech is detected based on a voice recognition result obtained by recognizing the first speech and a time length of the first speech.

### Aspect 7

The dialog apparatus according to any one of Aspects 1 to 6 further includes an emotion recognition unit. The emotion recognition unit recognizes an emotion of the user based on the first speech.

The speech output unit outputs the second speech corresponding to a recognition result of the emotion.

### Aspect 8

In the dialog apparatus according to Aspect 7, the emotion recognition unit recognizes the emotion based on an acoustic feature value extracted from the first speech and a voice recognition result obtained by recognizing the first speech.

### Aspect 9

The dialog apparatus according to any one of Aspects 1 to 8 further includes a response generation unit. The response generation unit generates a response speech to the first speech based on a voice recognition result obtained by recognizing the first speech.

The speech output unit outputs the second speech summarizing the voice recognition result when the response speech is generated.

### Aspect 10

In the dialog apparatus according to Aspect 9, the speech output unit outputs the second speech holding a turn when a generation time of the response speech exceeds a threshold.

### Aspect 11

The dialog apparatus according to any one of Aspects 1 to 10 further includes a motion detection unit. The motion detection unit detects a first motion of the user.

The speech output unit outputs a second motion corresponding to a detection result of the first motion from the dialog agent.

### Aspect 12

A dialog system includes a terminal apparatus operated by a user and a dialog apparatus that responds to a speech of the user by using a dialog agent. The terminal apparatus and the dialog apparatus communicate with each other via a network.

The dialog apparatus includes a speech detection unit and a speech output unit. The speech detection unit detects a first speech of the user.

The speech output unit controls the dialog agent to output a response to the first speech detected by the speech detection unit.

When a predetermined condition is satisfied, the speech output unit controls the dialog agent to output a second speech for facilitating dialog with the user before outputting the response.

### Aspect 13

A dialog method executed by a computer that responds to a speech of a user using a dialog agent includes detecting a first speech of the user.

The dialog method includes controlling the dialog agent to output a response to the first speech detected by the detecting.

The dialog method includes controlling the dialog agent to output a second speech for facilitating dialog with the user before outputting the response, when a predetermined condition is satisfied.

### Aspect 14

A non-transitory recording medium storing a plurality of instructions which, when executed by one or more processors that responds to a speech of a user using a dialog agent, causes the one or more processors to perform a dialog method.

The dialog method includes detecting a first speech of the user.

The dialog method includes controlling the dialog agent to output a response to the first speech detected by the detecting.

The dialog method includes controlling the dialog agent to output a second speech for facilitating dialog with the user before outputting the response, when a predetermined condition is satisfied.

Although the embodiments of the present disclosure have been described above, the present disclosure is not limited to such specific embodiments, and various modifications and applications are possible within the scope of the gist of the present disclosure described in the claims.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read only memory (CD-ROM) or a digital versatile disc (DVD), and/or the memory of an FPGA or ASIC.

1. An apparatus comprising:
circuitry configured to:
detect a first speech of a user;
control a dialog agent to output a response to the first speech that is detected; and
control the dialog agent to output a second speech for facilitating dialog with the user before outputting the response, when a predetermined condition is satisfied.

2. The apparatus according to claim 1,
wherein the second speech includes a speech for holding a turn or a speech for transferring a turn.

3. The apparatus according to claim 2,
wherein the circuitry is configured to manage a turn state of the dialog based on a detection state of the first speech, and
output the second speech when the predetermined condition related to the turn state is satisfied.

4. The apparatus according to claim 3,
wherein the circuitry shifts the turn state to the turn of the dialog agent when the end of the first speech is detected, and
output the second speech for holding the turn when the turn state has shifted to the turn of the dialog agent.

5. The apparatus according to claim 3,
wherein the circuitry is configured to shift the turn state to the turn of the user in a case where the first speech is detected when the turn state is the turn of the dialog agent, and
output the second speech for transferring the turn when the turn state has shifted to the turn of the user.

6. The apparatus according to claim 1,
wherein the circuitry is configured to determine whether the first speech is detected based on a voice recognition result obtained by recognizing the first speech and a time length of the first speech.

7. The apparatus according to claim 1,
wherein the circuitry is configured to recognize an emotion of the user based on the first speech,
and output the second speech based on the recognition result of the emotion of the user.

8. The apparatus according to claim 7,
wherein the circuitry is configured to recognize the emotion of the user based on an acoustic feature value extracted from the first speech and a voice recognition result obtained by recognizing the first speech.

9. The apparatus according to claim 1,
wherein the circuitry is configured to generate a response speech to the first speech based on a voice recognition result obtained by recognizing the first speech,
and output the second speech summarizing the voice recognition result when the response speech is generated.

10. The apparatus according to claim 9,
wherein the circuitry is configured to output the second speech for holding a turn when a generation time of the response speech exceeds a threshold.

11. The apparatus according to claim 1,
wherein the circuitry is configured to detect a first motion of the user,
and output a second motion based on a detection result of the first motion from the dialog agent.

12. A method comprising:
detecting a first speech of a user;
controlling a dialog agent to output a response to the first speech detected by the detecting; and
controlling the dialog agent to output a second speech for facilitating dialog with the user before outputting the response, when a predetermined condition is satisfied.

13. A non-transitory recording medium storing a plurality of instructions which, when executed by one or more processors, causes the one or more processors to perform a method, the method comprising:
detecting a first speech of a user;
controlling a dialog agent to output a response to the first speech detected by the detecting; and
controlling the dialog agent to output a second speech for facilitating dialog with the user before outputting the response, when a predetermined condition is satisfied.
